(19) United States
(12) Patent Application Publication
(10) Pub. No.: US 2025/0374361 A1
(43) Pub. Date: Dec. 4, 2025

(54) SYSTEM AND METHOD FOR OPTIMISING MOBILITY AFTER FAILURE

(71) Applicant: Samsung Electronics Co., Ltd., Suwon-si (KR)

(72) Inventor: Aby Kanneath ABRAHAM, Bangalore (IN)

(21) Appl. No.: 19/223,373

(22) Filed: May 30, 2025

(30) Foreign Application Priority Data
May 30, 2024 (IN) 202441041960
May 13, 2025 (IN) 2024 41041960

(51) Int. Cl. H04W 76/20; H04L 43/0805; H04W 76/30

(52) U.S. Cl. CPC H04W 76/20; H04L 43/0805; H04W 76/30

(57) ABSTRACT

The disclosure relates to a 5G or 6G communication system for supporting a higher data transmission rate. A user equipment (UE) and a method for managing the mobility of the UE following a radio link failure (RLF) in a communication network system are provided. The method includes receiving, by the UE, a radio resource control (RRC) reconfiguration message to perform ReconfigurationWithSync, determining whether the UE is configured with a successful handover report (SHR) configuration when connected to the source primary cell (PCell), determining whether the RRC reconfiguration message is received while a timer T316 is running, and, if the timer T316 is running, releasing the SHR configuration configured by the source PCell and releasing a threshold Percentage T304 if it is configured by a target PCell.

### CROSS-REFERENCE TO RELATED APPLICATION(S)

This application is based on and claims priority under 35 U.S.C. § 119(a) of an Indian Provisional application No. 202441041960, filed on May 30, 2024, in the Indian Intellectual Property Office, and of an Indian Non-Provisional patent application No. 202441041960, filed on May 13, 2025, in the Indian Intellectual Property Office, the disclosure of each of which is incorporated by reference herein in its entirety.

### BACKGROUND

### 1. Field

The disclosure relates to a telecommunication network. More particularly, the disclosure relates to system and method for optimizing mobility after failure.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a UE and a method for optimizing mobility of the UE after failure.

Another aspect of the disclosure is to provide a method for handling the mobility of UE after radio link failure (RLF).

Another aspect of the disclosure is to release a successful handover report (SHR) configuration received from source PCell and T304 threshold from target PCell when the T316 timer is running during the reception of a Radio Resource Control (RRC) configuration.

Additional aspects will be set forth in part in the description which follows and, in part, will be apparent from the description, or may be learned by practice of the presented embodiments.

In accordance with an aspect of the disclosure, a method performed by a user equipment (UE) in a communication network system is provided. The method includes receiving, from a base station, a radio resource control (RRC) reconfiguration message, identifying whether the UE is configured with a successful handover report (SHR) configuration when connected to a source PCell, in case that the reconfigurationWithSync IE is included in the RRC reconfiguration message, and releasing the SHR configuration configured by the source PCell, based on the identification that the UE is configured with the successHO-Config when connected to the source PCell.

In an embodiment of the disclosure, the method includes skipping by the UE SHR determination when the timer T316 is running. Further, the method includes maintaining by the UE T310 and T312 thresholds from the target PCell after skipping the SHR determination due to the timer T316 running.

In an embodiment of the disclosure, to receive the RRC Reconfiguration message for performing ReconfigurationWithSync, the method includes transmitting by the UE a master cell group (MCG) failure information for fast MCG link recovery when the RLF has occurred. Further, the method includes receiving by the UE the RRC reconfiguration message to perform a handover. The RRC reconfiguration includes an RRCreconfigurationwithsync parameter in a spCellConfig of the MCG.

In an embodiment of the disclosure, the UE is configured with SHR configuration when connected to the source PCell.

In accordance with another aspect of the disclosure, a user equipment (UE) in a communication network system is provided. The UE includes memory storing instructions, and processing circuitry coupled to the memory and configured, based at least partially on execution of the instructions, to cause the UE to, receive, from a base station, a radio resource control (RRC) reconfiguration message, identify whether a reconfiguration WithSync information element (IE) in a spCellConfig of a master cell group (MCG) is included in the RRC reconfiguration message, identify whether the UE is configured with a successHO-Config when connected to a source primary cell (PCell), in case that the reconfigurationWithSync IE is included in the RRC reconfiguration message, and release the successHO-Config configured by the source PCell, based on the identification that the UE is configured with the successHO-Config when connected to the source PCell.

According to the disclosure, the embodiments provide method and apparatus for optimizing mobility after failure, by releasing the successHO-Config configured by the source PCell and the thresholdPercentageT304 configured by the target PCell when the timer T316 is running.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of a user equipment (UE) for handling mobility after radio link failure (RLF) according to an embodiment of the disclosure;

FIG. 2 is a flow diagram that illustrates a method for handling mobility of the UE after RLF according to an embodiment of the disclosure;

FIG. 3 is a flow diagram that illustrates a method for handling SHR for LTM-based recovery by the UE according to an embodiment of the disclosure;

FIG. 4 is a flow diagram that illustrates a method for handling SHR configuration from source PCell while T316 is running according to an embodiment of the disclosure;

FIG. 5 is a flow diagram that illustrates a method for handling SHR configuration from target PCell while T316 is running according to an embodiment of the disclosure;

FIG. 6 is a flow diagram that illustrates a method for gNodeB (gNB) handling SHR configuration during fast MCG link recovery according to an embodiment of the disclosure; and

FIG. 7 is a flow diagram that illustrates a method for gNB handling SHR configuration during fast MCG link recovery according to an embodiment of the disclosure.

The same reference numerals are used to represent the same elements throughout the drawings.

### DETAILED DESCRIPTION OF INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In wireless communication technologies, such as fifth generation (5G) new radio (NR), user equipment (UE) mobility ensures seamless connectivity and service continuity as devices move across different cells. Mobility management in 5G NR is performed using various procedures, depending on the UE's operational mode. In RRC_IDLE mode, cell reselection is employed, while in RRC_CONNECTED mode, mobility is managed through handover procedures.

Until NR Release 17, mobility in RRC_CONNECTED mode has been primarily handled using network-controlled handover procedures. These procedures require explicit radio resource control (RRC) signaling, initiated by the gNodeB (gNB), the 5G base station. The handover process generally involves three main steps: handover preparation, handover execution, and handover completion. During this process, the gNB may configure the UE to report measurements, which are used to determine the target cell for handover. Subsequently, the gNB sends an RRC Reconfiguration message to the UE, instructing it to switch to the target cell. Upon accessing the target cell, the UE sends an RRC Reconfiguration Complete message to confirm the handover.

An alternative handover method introduced in 3^{rd} generation partnership project (3GPP) NR Release 16 involves configuring the UE with execution conditions for triggering handover. Once these conditions are met, the UE autonomously moves to the target cell and sends the RRC reconfiguration complete message. Despite these advancements, both methods involve the exchange of layer 3 (RRC) messages, resulting in significant signaling overhead and latency issues.

In addition to handover, dual connectivity scenarios introduce further complexity. In dual connectivity, the UE may perform primary secondary cell change (PSCellChange) or conditional PSCellChange, which are also considered layer 3 mobility procedures. These procedures can be categorized as secondary cell group (SCG) layer 3 mobility, while traditional handover and conditional handover (CHO) are referred to as master cell group (MCG) layer 3 mobility.

The 3^{rd} generation partnership project (3GPP) release 18 is considering lower layer triggered mobility (LTM) to address challenges in existing methods. According to 3GPP, the goal of LTM is to enable a serving cell change via L1/L2 signaling to reduce latency overhead and interruption time. The network (gNB) may configure the UE with multiple candidate cells to allow fast application of configurations for candidate cells. The network may further send medium access control (MAC) control element (CE) or L1 signaling (using a cell switch command) to dynamically switch the UE from a source cell to one of the configured candidate cells. Furthermore, LTM can be triggered based on L1 measurements rather than L3 measurements. The UE may receive LTM measurement configuration from the gNB, which includes L1 measurement configuration that specifies what to measure, how to report, what to report, and similar parameters.

A significant challenge arises in the context of successful handover report (SHR) determination when the UE applies RRC Reconfiguration due to Layer 1/Layer 2 (L1/L2) triggered mobility (LTM) based recovery. The current 3GPP specifications, such as TS 38.300, TS 38.331, and TS 38.321, do not disclose how the UE performs SHR determination under these conditions. Furthermore, after performing a handover triggered by fast MCG link recovery, the UE retains the thresholds configured by the source primary cell (PCell) and the T304 threshold configured by the target PCell. This can corrupt the SHR determination for subsequent PCell changes, leading to potential issues in maintaining accurate mobility management and network performance.

Thus, it is desired to address the above-mentioned disadvantages, issues, or other shortcomings, or at least provide a useful alternative.

It may be noted that, to the extent possible, like reference numerals have been used to represent like elements in the drawing. Furthermore, those of ordinary skill in the art will appreciate that elements in the drawing are illustrated for simplicity and may not necessarily have been drawn to scale. For example, the dimensions of some of the elements in the drawing may be exaggerated relative to other elements to improve the understanding of aspects of the disclosure. Further, the elements may have been represented in the drawing by symbols of the related art, and the drawings may show only those specific details that are pertinent to understanding the embodiments of the disclosure so as not to obscure the drawing with details that will be readily apparent to those of ordinary skill in the art having the benefit of the description herein.

As is traditional in the field, embodiments are described and illustrated in terms of blocks that carry out a described function or functions. These blocks, which are referred to herein as managers, units, modules, hardware components, or the like, are physically implemented by analog and/or digital circuits, such as logic gates, integrated circuits, microprocessors, microcontrollers, memory circuits, passive electronic components, active electronic components, optical components, hardwired circuits, and the like, and may optionally be driven by firmware and software. The circuits, for example, may be embodied in one or more semiconductor chips or on substrate supports, such as printed circuit boards and the like. The circuits constituting a block may be implemented by dedicated hardware or by a processor (e.g., one or more programmed microprocessors and associated circuitry) or by a combination of dedicated hardware to perform some functions of the block and a processor to perform other functions of the block. Each block of the embodiments may be physically separated into two or more interacting and discrete blocks without departing from the scope of the proposed method. Likewise, the blocks of the embodiments may be physically combined into more complex blocks without departing from the scope of the proposed method.

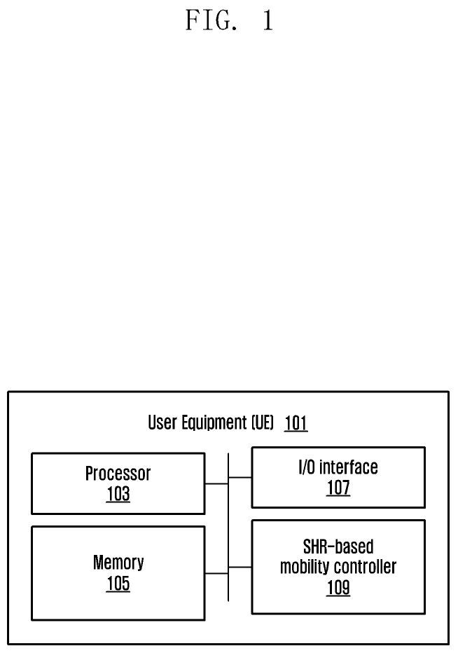

Referring now to the drawings, and more particularly to FIGS. 1 through 7 where similar reference characters denote corresponding features consistently throughout the figures, there are shown preferred embodiments.

Embodiments disclosed herein provide a user equipment (UE) and method for optimizing mobility after failure. The proposed method includes a mechanism for the UE to perform successful handover report (SHR) determination when the UE applies radio resource control (RRC) reconfiguration due to lower layer triggered mobility (LTM) based recovery. In an embodiment of the disclosure, the UE avoids SHR determination when the RRC Reconfiguration is applied due to LTM based recovery. When the UE performs an LTM cell switch due to LTM based recovery, the UE does not perform SHR determination.

In an embodiment of the disclosure, when the UE receives an RRC message, such as RRC reconfiguration to perform handover for fast master cell group (MCG) link recovery (i.e., the UE received an RRC reconfiguration to perform handover while a timer, such as NR timer T316 is running), the UE skips SHR determination (the UE does not log or report SHR for this case) and releases the SHR thresholds configured by the source primary cell (PCell). Specifically, the UE releases SHR thresholds, such as thresholdPercentageT310 and thresholdPercentageT312 in NR after skipping SHR determination for the handover when T316 was running. Additionally, in an embodiment of the disclosure, when the UE receives an RRC message, such as RRC Reconfiguration to perform handover for fast MCG link recovery (i.e., the UE received an RRC Reconfiguration to perform handover while a timer, such as NR timer T316 is running), the UE skips SHR determination (the UE does not log or report SHR for this case) and releases the T304 threshold configured by the target PCell.

Upon the declaration of a radio link failure (RLF), the user equipment (UE) follows specific procedures based on the type of handover or mobility management involved. In the case of conditional handover (CHO) for RLF in the source cell, the UE selects a suitable cell. If the selected cell is a CHO candidate and the network has configured the UE to attempt CHO after RLF, the UE will attempt CHO execution once. If this attempt fails, re-establishment is performed. If a suitable cell is not found within a time after RLF is declared, the UE enters RRC_IDLE. For master cell group (MCG) link transfer management (LTM) in the event of RLF in the source cell, the UE selects a suitable cell. If the selected cell is an LTM candidate cell and the network has configured the UE to attempt LTM after RLF, the UE will attempt RACH-based LTM execution once, a process known as LTM-based recovery. If this attempt fails, re-establishment is performed.

When an initial CHO execution attempt fails or a handover (HO) fails, the UE performs cell selection. If the selected cell is a CHO candidate and the network has configured the UE to try CHO after a handover or CHO failure, the UE attempts CHO execution once. Otherwise, re-establishment is performed. In the case of an LTM execution attempt triggered by an LTM cell switch command MAC CE failure or HO failure, the UE performs cell selection. If the selected cell is an LTM candidate cell and the network has configured the UE to try LTM after a handover or LTM execution failure, the UE attempts RACH-based LTM execution once, also known as LTM-based recovery. Otherwise, re-establishment is performed.

For fast MCG link recovery in dual connectivity (MR-DC), an RRC procedure is initiated where the UE sends an MCG Failure Information message to the MN via the SCG upon detecting a radio link failure on the MCG. During the fast MCG link recovery, the UE suspends MCG transmissions for all radio bearers except SRB0 and any BH RLC channels. The failure is reported with an MCGFailureInformation message to the MN via the SCG using the SCG leg of split SRB1 or SRB3. The UE includes in the MCGFailureInformation message the measurement results available according to the current measurement configuration of both the MN and the SN. Once the fast MCG link recovery is triggered, the UE maintains the current measurement configurations from both the MN and the SN and continues measurements based on the configuration from the MN and the SN, if possible. The UE initiates the RRC connection re-establishment procedure if it does not receive an RRCConnectionReconfiguration message, RRCReconfiguration message, MobilityFromNRCommand message, MobilityFromEUTRACommand message, RRCConnectionRelease message, or RRCRelease message within a time (timer T316 in NR) after the fast MCG link recovery was initiated.

A 5G new radio (NR) radio access network, also known as NG-next generation radio network (RAN), comprises a number of NR base stations known as gNBs. These gNBs can be connected to each other through the Xn interface and are connected to various core network elements, such as the access and mobility management function (AMF) and user plane function (UPF). Additionally, gNBs can be divided into two physical entities named centralized unit (CU) and distributed unit (DU). The CU supports the higher layers of the protocol stack, including session data application protocol (SDAP), packet data convergence protocol (PDCP), and radio resource control (RRC). In contrast, the DU supports the lower layers of the protocol stack, such as radio link control (RLC), medium access control (MAC), and the physical layer. The gNB can have multiple cells serving many user equipments (UEs).

A large number of algorithms and configuration parameters are used in the NG-RAN. Identifying the radio parameters is a challenging task, and operators have traditionally resorted to manual techniques like drive tests to determine these parameters. However, manual parameter tuning is a costly operation, as it depends on numerous factors, such as the number of users, number of neighbors, maximum throughput in the cell, and average throughput in the cell. Furthermore, whenever a neighboring gNB is installed or a new service is introduced, many of these manual operations need to be repeated.

To address this problem, 3GPP introduced self-organizing networks (SON) techniques in wireless technologies like NR. SON was first introduced in 3GPP Release 9 in LTE. SON solutions can be categorized into three types: self-configuration, self-optimization, and self-healing. The SON architecture can be centralized, distributed, or a hybrid solution. Mobility robustness optimization (MRO) is a SON technique used to optimize various parameters related to mobility.

According to 3GPP specifications, such as TS 38300 V17.3.0, mobility robustness optimization aims at detecting and enabling the correction of the following problems: connection failure due to intra-system or inter-system mobility, unnecessary inter-system handover (HO), such as too early inter-system HO from NR to E-UTRAN without radio link failure, and Inter-system HO ping-pong.

The disclosure provides means to distinguish problems related to mobility robustness optimization (MRO) from those related to NR coverage and other unrelated issues. One of the primary functions of MRO is to detect sub-optimal successful handover events. The aim is to identify underlying conditions during successful ordinary handovers, successful dual active protocol stack (DAPS) handovers, or successful conditional handovers.

For the analysis of successful handovers, the user equipment (UE) supports a successful handover report (SHR). This report is based on configuration by the network, for example, through information element (IE) successHO-Config as defined in 3GPP Technical Specification TS 38331 in NR. If the configuration is received, the UE makes the successful handover report available to the network. Upon retrieval of a successful handover report, the receiving node may analyze whether its mobility configuration needs adjustment.

TABLE 1
Network configures the UE for successful handover reporting. In
NR, gNB configures UE for successful handover reporting through
OtherConfig in RRCReconfiguration. OtherConfig-v1700 ::=
SEQUENCE {

| | |
|---|---|
| ul-GapFR2-PreferenceConfig-r17 | ENUMERATED {true} |

OPTIONAL, -- Need R

| | |
|---|---|
| musim-GapAssistanceConfig-r17 | SetupRelease {MUSIM- |
| GapAssistanceConfig-r17} | OPTIONAL, -- Need M |
| musim-LeaveAssistanceConfig-r17 | SetupRelease {MUSIM- |
| LeaveAssistanceConfig-r17} | OPTIONAL, -- Need M |
| successHO-Config-r17 | SetupRelease {SuccessHO-Config- |
| r17} | OPTIONAL, -- Need M |
| maxBW-PreferenceConfigFR2-2-r17 | ENUMERATED {true} |

OPTIONAL, -- Cond maxBW

| | |
|---|---|
| maxMIMO-LayerPreferenceConfigFR2-2-r17 | ENUMERATED |
| {true} | OPTIONAL, -- Cond maxMIMO |
| minSchedulingOffsetPreferenceConfigExt-r17 | ENUMERATED |
| {true} | OPTIONAL, -- Cond minOffset |
| rlm-RelaxationReportingConfig-r17 | SetupRelease {RLM- |
| RelaxationReportingConfig-r17} | OPTIONAL, -- Need M |
| bfd-RelaxationReportingConfig-r17 | SetupRelease {BFD- |
| RelaxationReportingConfig-r17} | OPTIONAL, -- Need M |
| scg-DeactivationPreferenceConfig-r17 | SetupRelease {SCG- |
| DeactivationPreferenceConfig-r17} | OPTIONAL, -- Cond SCG |
| rrm-MeasRelaxationReportingConfig-r17 | SetupRelease {RRM- |
| MeasRelaxationReportingConfig-r17} | OPTIONAL, -- Need M |
| propDelayDiffReportConfig-r17 | SetupRelease |
| {PropDelayDiffReportConfig-r17} | OPTIONAL -- Need M |

}

SuccessHO-Config (also may be referred to as SHR configuration) includes some thresholds and may also include some conditions which the UE evaluates at the time of handover. Based on the evaluation, the UE logs a Successful Handover report.

In NR, SuccessHO-Config is defined as shown in below Table 2:

TABLE 2

| | |
|---|---|
| SuccessHO-Config-r17 ::= | SEQUENCE { |
| thresholdPercentageT304-r17 | ENUMERATED {p40, p60, p80, |
| spare5, spare4, spare3, spare2, spare1} | OPTIONAL, --Need R |
| thresholdPercentageT310-r17 | ENUMERATED {p40, p60, p80, |
| spare5, spare4, spare3, spare2, spare1} | OPTIONAL, --Need R |
| thresholdPercentageT312-r17 | ENUMERATED {p20, p40, p60, p80, |
| spare4, spare3, spare2, spare1} | OPTIONAL, --Need R |
| sourceDAPS-FailureReporting-r17 | ENUMERATED {true} |

OPTIONAL, --Need R
...
}

TABLE 3
thresholdPercentageT304
This field indicates the threshold for the ratio in percentage between the
elapsed T304 timer and the configured value of the T304 timer. Value
p40 corresponds to 40%, value p60 corresponds to 60% and so on. This
field is set in the otherConfig configured by the target cell of the
handover.
thresholdPercentageT310
This field indicates the threshold for the ratio in percentage between the
elapsed T310 timer and the configured value of the T310 timer. Value
p40 corresponds to 40%, value p60 corresponds to 60% and so on. This
field is set in the otherConfig configured by the source cell of the
handover.
thresholdPercentageT312
This field indicates the threshold for the ratio in percentage between the
elapsed T312 timer and the configured value(s) of the T312 timer. Value
p20 corresponds to 20%, value p40 corresponds to 40% and so on. This
field is set in the otherConfig configured by the source cell of the
handover.

In NR, R18, the evaluation of successful handover involves the following steps (based on TS 38.331 V18.0.0):

### 5.3.5.9Other Configuration

The UE shall:
1> if successHO-Config is set to setup:
   2> consider itself to be configured to provide the successful handover information in accordance with 5.7.10.6;
1> else:
   2> consider itself not to be configured to provide the successful handover information.

In NR, the evaluation of successful handover is performed according to the below.

### For Intra-NR Mobility

1> set the content of the RRCReconfigurationComplete message as follows:
   2> if the RRCReconfiguration includes the reconfiguration WithSync in spCellConfig of an MCG:
      3> if the UE was configured with successHO-Config when connected to the source PCell:
         4> if the applied RRCReconfiguration is not due to a conditional reconfiguration execution upon cell selection performed while timer T311 was running, as defined in 5.3.7.3; or
         4> if the applied RRCReconfiguration is not received when T316 was running:
         5> perform the actions for the successful handover report determination as specified in clause 5.7.10.6, upon successfully completing the Random Access procedure triggered for the reconfiguration WithSync in spCellConfig of the MCG;

### For Inter-NR Mobility

5.4.3.4Successful Completion of the Mobility from NR

Upon successfully completing the handover, at the source side the UE shall:
1> reset MAC;
1> stop all timers that are running except T325, T330 and T400;
1> release ran-NotificationAreaInfo, if stored;
1> release the AS security context including the KRRCenc key, the KRRCint key, the KUPint key and the KUPenc key, if stored;
1> release all radio resources, including release of the RLC entity and the MAC configuration;
1> release the associated PDCP entity and SDAP entity for all established RBs;

NOTE: PDCP and SDAP configured by the source RAT prior to the handover that are reconfigured and re-used by target RAT when delta signaling (i.e., during inter-RAT intra-system handover when fullConfig is not present) is used, are not released as part of this procedure.
1> if T316 was not running at the time of receiving MobilityFromNRCommand and if the UE was configured with successHO-Config when connected to the source PCell and the targetRAT-Type is set to eutra:
   2> perform the actions for the successful handover report determination for inter-RAT handover as specified in clause 5.7.10.6.
1> if the targetRAT-Type is set to eutra and the nas-SecurityParamFromNR is included: or
1> if the targetRAT-Type is set to utra-fdd:
   2> indicate the release of the RRC connection to upper layers together with the release cause ‘other’.

If the conditions for successful handover configuration are satisfied, UE logs successful handover report (SHR). In NR SHR is defined as follows:

| | |
|---|---|
| SuccessHO-Report-r17 ::= | SEQUENCE { |
| sourceCellInfo-r17 | SEQUENCE { |
| sourcePCellId-r17 | CGI-Info-Logging-r16, |
| sourceCellMeas-r17 | MeasResultSuccessHONR-r17 |

OPTIONAL,

| | |
|---|---|
| rlf-InSourceDAPS-r17 | ENUMERATED {true} |

OPTIONAL
},

| | |
|---|---|
| targetCellInfo-r17 | SEQUENCE { |
| targetPCellId-r17 | CGI-Info-Logging-r16, |
| targetCellMeas-r17 | MeasResultSuccessHONR-r17 |

OPTIONAL
},

| | |
|---|---|
| measResultNeighCells-r17 | SEQUENCE { |
| measResultListNR-r17 | MeasResultList2NR-r16 |

OPTIONAL,

| | |
|---|---|
| measResultListEUTRA-r17 | MeasResultList2EUTRA-r16 |

OPTIONAL

| | |
|---|---|
| } | OPTIONAL, |
| locationInfo-r17 | LocationInfo-r16 |

OPTIONAL,

| | |
|---|---|
| timeSinceCHO-Reconfig-r17 | TimeSinceCHO-Reconfig-r17 |

OPTIONAL,

| | | |
|---|---|---|
| shr-Cause-r17 | SHR-Cause-r17 | OPTIONAL, |

| | |
|---|---|
| ra-InformationCommon-r17 | RA-InformationCommon-r16 |

OPTIONAL,

| | |
|---|---|
| upInterruptionTimeAtHO-r17 | UPInterruptionTimeAtHO-r17 |

OPTIONAL,

| | | |
|---|---|---|
| c-RNTI-r17 | RNTI-Value | OPTIONAL, |

```
  ...,
  [[
```

| | |
|---|---|
| eutraTargetCellInfo-r18 | SEQUENCE { |
| targetPCellId-r18 | CGI-InfoEUTRALogging, |
| targetCellMeas-r18 | MeasQuantityResultsEUTRA |

OPTIONAL

| | |
|---|---|
| } | OPTIONAL, |
| measResultServCell-RSSI-r18 | RSSI-Range-r16 |

OPTIONAL,
measResultNeighFreqList-RSSI-r18

| | |
|---|---|
| MeasResultNeighFreqList-RSSI-r18 | OPTIONAL, |
| eutra-C-RNTI-r18 | EUTRA-C-RNTI |

OPTIONAL,

| | |
|---|---|
| timeSinceSHR-r18 | TimeSinceSHR-r18 |

OPTIONAL
]]
}

5.7.10.6 Actions for the successful handover report (SHR) determination. The UE shall for the PCell:
1> If the procedure is triggered due to successful completion of reconfiguration with sync and if the ratio between the value of the elapsed time of the timer T304 and the configured value of the timer T304 included in the last applied RRCReconfiguration message including the reconfiguration WithSync is greater than thresholdPercentageT304 if included in the successHO-Config received before executing the last reconfiguration with sync or
1> If the procedure is triggered due to successful completion of reconfiguration with sync and if the ratio between the value of the elapsed time of the timer T310 and the configured value of the timer T310 configured while the UE was connected to the source PCell before executing the last reconfiguration with sync is greater than thresholdPercentageT310 included in the successHO-Config if configured by the source PCell before executing the last reconfiguration with sync or
1> If the procedure is triggered due to successful completion of reconfiguration with sync and if the T312 associated with the measurement identity of the target cell was running at the time of initiating the execution of the reconfiguration with sync procedure and if the ratio between the value of the elapsed time of the timer T312 and the configured value of the timer T312 configured while the UE was connected to the source PCell before executing the last reconfiguration with sync is greater than thresholdPercentageT312 included in the successHO-Config if configured by the source PCell before executing the last reconfiguration with sync or
1> If the procedure is triggered due to successful completion of reconfiguration with sync and if sourceDAPS-FailureReporting is included in the successHO-Config before executing the last reconfiguration with sync and is set to true and if the last executed handover was a DAPS handover and if an RLF occurred at the source PCell during the DAPS handover while T304 was running or
1> If the procedure is triggered due to successful completion of mobility from NR to E-UTRA and if the ratio between the value of the elapsed time of the timer T310 and the configured value of the timer T310 configured while the UE was connected to the source PCell before executing the last Mobility from NR to E-UTRA is greater than thresholdPercentageT310 included in the successHO-Config if configured by the source PCell before executing the last Mobility from NR to E-UTRA or
1> If the procedure is triggered due to successful completion of Mobility from NR to E-UTRA and if the T312 associated with the measurement identity of the target cell was running at the time of initiating the execution of the Mobility from NR to E-UTRA and if the ratio between the value of the elapsed time of the timer T312 and the configured value of the timer T312 configured while the UE was connected to the source PCell before executing the last Mobility from NR to E-UTRA is greater than thresholdPercentageT312 included in the successHO-Config if configured by the source PCell before executing the last Mobility from NR to E-UTRA
2> store the successful handover information in VarSuccessHO-Report and determine the content in VarSuccessHO-Report as follows
3> clear the information included in VarSuccessHO-Report if any
<various steps for SHR content determination release discard etc>

The UE indicates the availability of SHR in RRC complete messages. In NR, the messages can be RRCSetupComplete, RRCResumeComplete, and RRCReconfigurationComplete. Further, the UE may receive a request to send SHR and report the SHR to the network.

In NR, the request to include SHR is sent in the UEInformationRequest message, and the UE sends the SHR to gNB through the UEInformationResponse message.

For the purpose of the disclosure, 3GPP TS 38.331 v 18.10 is considered as relevant background.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

FIG. 1 is a block diagram of a UE 101 for handling mobility after RFL according to an embodiment of the disclosure.

Referring to FIG. 1, examples of the UE 101 can include, but not limited to a user equipment, consumer electronics (such as mobile phones and smartphones), tablets, wearable devices, television, computing devices (such as laptops, notebooks, desktops, workstations, or the like), Internet of things (IoT) devices, automotive systems (such as connected cars, autonomous vehicles, vehicle-to-everything (V2X) communication devices, or the like), enterprise devices, such as robotics, specialized equipment (such as medical devices, public safety devices, or the like), media devices (such as gaming consoles, streaming devices, or the like).

Examples of network side devices are, such as but is not limited to base stations (such as macro cells, small cells, femtocells, picocells in fourth generation (4G), 5G or 6G) for wireless communication, antennas and RF Units (e.g., MIMO, beamforming) to enhance signal coverage and data throughput, core network equipment (e.g., MMEs, S-GWs, P-GWs in 4G, AMFs, UPFs in 5G, network nodes in 6G) for data routing, mobility, and session control, network function virtualization (NFV) and software-defined networking (SDN) for dynamic resource allocation and scalability, edge computing nodes (e.g., MEC servers) for low-latency processing, backhaul and transport equipment (e.g., fiber-optic links, microwave relays, Ethernet switches) to connect base stations to the core network, network management systems (NMS) and operation support systems (OSS) for network configuration, fault management, and optimization, radio network controllers (RNCs) in 3G, distributed units (DUs), and centralized units (CUs) in 5G, network slicing components for virtualized resource allocation, security elements (e.g., firewalls, IDS, AAA servers) for secure communication

Examples of the telecommunication network system include, but are not limited to, cellular networks (such as 2G, 3G, 4G, 5G, Beyond 5G (B5G)/6G, or advanced cellular networks), local area networks (LANs) (such as Wi-Fi, Li-Fi, or the like), personal area networks (PANs) (such as Bluetooth, Zigbee, Z-Wave, or the like), wide area networks (WANs) (such as satellite communication networks, long range wide area network, narrowband IoT, low-bandwidth communication for IoT, or the like), metropolitan area networks (MANs), machine-to-machine (M2M), ad hoc and mesh networks, emerging and advanced networks.

The UE 101 includes a processor 103, memory 105, an I/O interface 107, and a SHR-based mobility controller 109. Furthermore, the processor 103 of the UE 101 communicates with the memory 105, the I/O interface 107, and the SHR-based mobility controller 109. The processor 103 is configured to execute instructions stored in the memory 105 and to perform various processes. The processor 103 can include one or a plurality of processors, can be a general-purpose processor, such as a central processing unit (CPU), an application processor (AP), or the like, a graphics-only processing unit, such as a graphics processing unit (GPU), a visual processing unit (VPU), and/or an artificial intelligence (AI) dedicated processor, such as a neural processing unit (NPU).

Furthermore, the memory 105 of the UE 101 includes storage locations that can be addressed through the processor 103. The memory 105 is not limited to volatile or non-volatile memory and can include one or more computer-readable storage media. Non-volatile storage elements, such as magnetic hard disks, optical discs, floppy discs, flash memories, EPROM, or EEPROM memories can also be included in the memory 105. Further, the memory 105 of the UE 101 can store various information received from the network. The UE 101 can store several pieces of information, such as SHR configuration, RRCreconfiguration and the like. In addition, the memory 105 stores information about source primary cell (PCell) and the target PCell.

The I/O interface 107 transmits information between the memory 105 and external peripheral devices, which are input-output devices associated with the UE 101. The I/O interface 107 receives various information from the PCell and target PCell.

The SHR-based mobility controller 109 communicates with the I/O interface 107 and the memory 105 for handling mobility of UE after RLF in a telecommunication network. The SHR-based mobility controller 109 is an innovative hardware that is realized through the physical implementation of both analog and digital circuits, including logic gates, integrated circuits, microprocessors, microcontrollers, memory circuits, passive and active electronic components, as well as optical components. The analog circuits are responsible for signal conditioning and interfacing with various sensors, while the digital circuits handle data processing and control functions. The microprocessors and microcontrollers execute firmware that manages the SHR-based mobility controller's operations, and the memory circuits store configuration data and operational parameters. The optical components may be used for high-speed data transmission and reception, enhancing the overall performance of the SHR-based mobility controller.

The SHR-based mobility controller 109 receives the RRC reconfiguration message for performing Reconfiguration WithSync. Further, the SHR-based mobility controller 109 determines whether the UE is configured with the SHR configuration when connected to a source PCell. The SHR-based mobility controller 109 also determines whether the RRC Reconfiguration message is received while a timer T316 is running. Additionally, the SHR-based mobility controller 109 releases the SHR configuration configured by the source PCell and releases a threshold Percentage T304 if configured by the target PCell when the timer T316 is running. The SHR-based mobility controller 109 ensures seamless transition by dynamically adjusting the configuration parameters based on the network conditions and the state of the UE. This includes monitoring signal strength, quality of service (QOS) metrics, and other relevant parameters to optimize the handover process.

In an embodiment of the disclosure, the SHR-based mobility controller 109 skips SHR determination when the timer T316 is running. Further, the SHR-based mobility controller 109 maintains T310 and T312 thresholds from the target PCell after skipping the SHR determination due to the timer T316 running. This approach helps in reducing unnecessary processing and potential delays in the handover process. The SHR-based mobility controller 109 uses a sophisticated algorithm to decide when to skip the SHR determination, taking into account factors, such as the current network load, UE mobility patterns, and historical performance data. By maintaining the T310 and T312 thresholds, the SHR-based mobility controller ensures that the UE remains connected and operational, even during periods of high network activity.

In an embodiment of the disclosure, to receive the RRC Reconfiguration message for performing Reconfiguration WithSync, the SHR-based mobility controller 109 transmits the MCG failure information for fast MCG link recovery when the RLF has occurred. Further, the SHR-based mobility controller 109 receives the RRC reconfiguration message to perform a handover. The RRC reconfiguration includes an Reconfigurationwithsync parameter in a spCellConfig of the MCG. This parameter is used for synchronizing the UE with the target cell, ensuring that the handover process is completed efficiently and with minimal disruption to the user experience. The SHR-based mobility controller 109 also implements error-checking mechanisms to verify the integrity of the received RRC reconfiguration message, preventing potential issues during the handover.

In an embodiment of the disclosure, the UE is configured with SHR configuration when connected to the source PCell. The SHR configuration includes specific parameters and settings that optimize the UE's performance and connectivity within the source PCell. These parameters may include frequency bands, power levels, and timing advance values, among others. The SHR-based mobility controller 109 monitors the UE's 101 connection status and adjusts the SHR configuration as needed to maintain performance. This dynamic adjustment capability ensures that the UE can seamlessly transition between cells, even in challenging network environments.

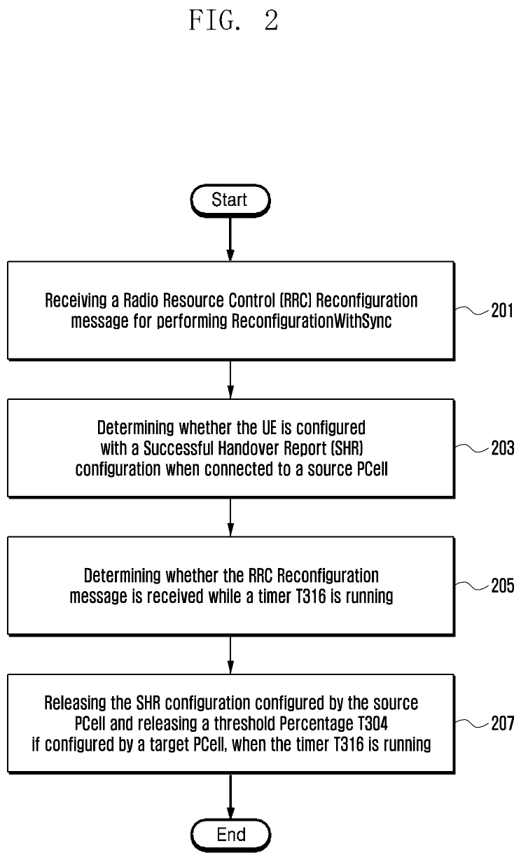

FIG. 2 is a flow diagram that illustrates a method for handling mobility of a UE after RLF, according to an embodiment of the disclosure.

Referring to FIG. 2, at operation 201, the method includes receiving the RRC Reconfiguration message for performing ReconfigurationWithSync. This message is used for initiating the reconfiguration process, ensuring that the UE 101 can synchronize with the new cell. For example, the RRC Reconfiguration message can include parameters, such as the target cell's identity, frequency information, and other configurations, such as radio bearer configuration, measurement configuration, mobility configuration to facilitate a seamless mobility. Additionally, the message can include instructions for the UE to adjust its transmission power and update its security keys to maintain secure communication.

At operation 203, the method includes determining whether the UE 101 is configured with the SHR configuration when connected to a source PCell. The determination process involves checking the UE's current configuration settings and verifying if the SHR parameters are present. If the SHR configuration is present, the UE may store various information, such as the location information, radio measurements at the UE, wireless local area network (WLAN) measurements or the like, for optimizing the mobility.

At operation 205, the method includes determining whether the RRC Reconfiguration message is received while a timer T316 is running. If the timer is active, it indicates that the UE 101 is in the midst of a fast link recovery procedure, and special handling may be required. In an embodiment of the disclosure, the method includes pausing various operations on the secondary cell group, such as measurements and evaluation of the SCG mobility, ensuring that the UE 101 can complete the process without interruption. Further, the UE may need to update its internal state to reflect the ongoing reconfiguration and prepare for any subsequent steps.

At operation 207, the method includes releasing, by the UE 101, the SHR configuration configured by the source PCell and releasing a threshold Percentage T304 if configured by a target PCell, when the timer T316 is running. This allows the UE to transition seamlessly from the source PCell to the target PCell by releasing outdated configurations and adopting new ones. The release of the SHR configuration involves removing the configuration from the source PCell which is configured according to the deployment of source PCell and which may not be applicable for the target PCell or any other serving cells to which the UE may move in the future before moving to a non-connected state. The threshold Percentage T304 may be related to the UE's random access performance, and releasing it allows the UE to use the configuration from target PCell or any other serving cells to which the UE may move in the future easily.

In an embodiment of the disclosure, the method includes skipping the SHR determination when the timer T316 is running. Further, the method includes maintaining T310 and T312 thresholds from the target PCell after skipping the SHR determination due to the timer T316 is running. This helps to avoid unnecessary logging SHR thereby saving UE memory and avoiding overwriting the useful optimization information. The T310 and T312 thresholds may be used by the UE during a handover from the target cell to a new cell, thereby avoiding additional signaling for further handovers. By maintaining these thresholds, the UE ensures that it remains compliant with the target PCell's requirements, including a quick mobility to a new cell when the target cell does not get enough time to configure the new thresholds.

In an embodiment of the disclosure to receive the method includes transmitting the MCG failure information for fast MCG link recovery, when the RLF has occurred. Further, the method includes receiving the RRC Reconfiguration message to perform the handover that includes the ReconfigurationWithSync parameter in a spCellConfig of the MCG. The transmission of the MCG failure information allows the network to quickly identify and address any issues affecting the UE's 101 connectivity. The RRC reconfiguration message, with the Reconfiguration WithSync parameter, ensures that the UE 101 can synchronize with the new cell and complete the handover process efficiently. This parameter may include details, such as the target cell's synchronization signals and timing information, enabling the UE 101 to align its operations with the new cell seamlessly.

In an embodiment the UE 101 is configured with SHR configuration when connected to the source PCell. This configuration allows the UE 101 to provide information to the network to optimize its mobility processes and reduce mobility failures. The SHR configuration may include parameters, such as the thresholds related to the timers, such as RLF timers or handover timers. By configuring the UE 101 with these parameters, the network ensures that the UE can provide detailed information for optimization of mobility events.

In an embodiment of the disclosure, the UE 101 avoids (i.e., skips/does not perform) SHR determination if the RRCReconfiguration is applied due to LTM based recovery. When the UE 101 performs LTM cell switch due to LTM based recovery, the UE 101 does not perform SHR determination, and the UE 101 does not log SHR or report SHR for this case. If there is already SHR stored, it will not be discarded and will be reported if the network retrieves the SHR. This helps to streamline the recovery process by eliminating unnecessary steps. The lower layer triggered mobility (LTM) based recovery ensures that the UE 101 can quickly switch to a new cell and maintain connectivity, even in radio link failure (RLF). By retaining the stored SHR information, the UE 101 can provide data to the network for future optimizations and troubleshooting.

In an embodiment of the disclosure, according to TS 38.331,
3> if the UE was configured with successHO-Config when connected to the source PCell:
   4> if the applied RRCReconfiguration is not due to a conditional reconfiguration execution upon cell selection performed while timer T311 was running or LTM cell switch upon cell selection performed while timer T311 was running, as defined in 5.3.7.3; or
   4> if the applied RRCReconfiguration is not received when T316 was running:
      5> perform the actions for the successful handover report determination as specified in clause 5.7.10.6, upon successfully completing the Random Access procedure triggered for the reconfiguration WithSync in spCellConfig of the MCG.

In an embodiment of the disclosure, if the UE 101 receives an RRC message, such as RRCReconfiguration to perform handover for the fast MCG link recovery (i.e., UE received an RRCReconfiguration to perform handover while a timer, such as NR timer T316 is running), the UE 101 skips SHR determination (UE does not log or report SHR for this case) and releases the SHR thresholds configured by the source PCell, i.e., the UE 101 releases SHR thresholds, such as thresholdPercentageT310 and thresholdPercentageT312 in NR after skipping SHR determination for the handover when T316 was running.

In an embodiment of the disclosure, if the UE 101 receives an RRC message, such as RRCReconfiguration to perform handover for the fast MCG link recovery (i.e., UE received an RRCReconfiguration to perform handover while a timer, such as NR timer T316 is running), the UE 101 skips SHR determination (UE does not log or report SHR for this case) and releases the T304 threshold configured by the target PCell.

The UE 101 performing handover while a timer, such as T316 is running releases the SHR configuration configured by the source PCell and thresholds, such as T304 which were meant for the skipped SHR determination.

In an embodiment of the disclosure, according to TS 38.331,
1> set the content of the RRCReconfigurationComplete message as follows:
   2> if the RRCReconfiguration 2> includes the reconfiguration WithSync in spCellConfig of an MCG:
      3> if the UE was configured with successHO-Config when connected to the source PCell:
         4> if the applied RRCReconfiguration is not due to a conditional reconfiguration execution upon cell selection performed while timer T311 was running, as defined in 5.3.7.3; or
         4> if the applied RRCReconfiguration is not received when T316 was running:
         5> perform the actions for the successful handover report determination as specified in clause 5.7.10.6, upon successfully completing the Random Access procedure triggered for the reconfiguration WithSync in spCellConfig of the MCG;
      4> if the applied RRCReconfiguration is received when T316 was running:
         5> release successHO-Config configured by the source PCell and thresholdPercentageT304 if configured by the target PCell.

In an embodiment of the disclosure, a base station (MN) sending an RRC Reconfiguration message for handover (i.e., in NR sending RRCReconfiguration including Reconfiguration WithSync) for fast MCG link recovery (i.e., after receiving MCGFailureInformation) releases the successHO-Config configured by the source PCell in the RRC Reconfiguration message. i.e., in NR gNB releases thresholdPercentageT310 and thresholdPercentageT312 if they are configured by the source PCell while sending RRCReconfiguration including Reconfiguration WithSync for fast MCG link recovery.

In an embodiment of the disclosure, a base station (MN) sending an RRC Reconfiguration message for handover (i.e., in NR sending RRCReconfiguration including Reconfiguration WithSync) for fast MCG link recovery (i.e., after receiving MCGFailureInformation) avoids the configuring T304 threshold (thresholdPercentageT304) in the RRC Reconfiguration message. i.e., in NR gNB avoids configuring thresholdPercentageT304 while sending RRCReconfiguration including Reconfiguration WithSync for fast MCG link recovery.

In an embodiment of the disclosure, according to TS 38.331,

TABLE 4
thresholdPercentageT304
This field indicates the threshold for the ratio in percentage between the
elapsed T304 timer and the configured value of the T304 timer. Value
p40 corresponds to 40%, value p60 corresponds to 60% and so on. This
field is set in the otherConfig configured by the target cell of the
handover. If the handover is due to fast MCG link recovery, target cell
does not include this field.
thresholdPercentageT310
This field indicates the threshold for the ratio in percentage between the
elapsed T310 timer and the configured value of the T310 timer. Value
p40 corresponds to 40%, value p60 corresponds to 60% and so on. This
field is set in the otherConfig configured by the source cell of the
handover. For a handover is due to fast MCG link recovery, target cell
releases thresholdPercentageT310 configured by the source cell.
thresholdPercentageT312
This field indicates the threshold for the ratio in percentage between the
elapsed T312 timer and the configured value(s) of the T312 timer. Value
p20 corresponds to 20%, value p40 corresponds to 40% and so on. This
field is set in the otherConfig configured by the source cell of the
handover. For a handover is due to fast MCG link recovery, target cell
releases thresholdPercentageT312 configured by the source cell.

In an embodiment of the disclosure, the UE 101 release SHR configuration during fast MCG link recovery.

In an embodiment of the disclosure, the UE 101 releases SHR configuration during MCG failure information procedure.

In an embodiment of the disclosure, the UE 101 releases SHR configuration during the initiation of MCG failure information procedure.

In an embodiment of the disclosure, in case of MR-DC, the UE 101 configured with split SRB1 or SRB3 initiates the procedure to report MCG failures when neither MCG nor SCG transmission is suspended, the SCG is not deactivated, t316 is configured, and when the following condition is met; or

In case of MP, a MP remote UE 101 configured with split SRB1 initiates the procedure to report direct path failures when neither MCG (i.e., direct path) nor indirect path transmission is suspended, t316 is configured, and when the following condition is met:
1> upon detecting radio link failure of the MCG, in accordance with 5.3.10.3, while T316 is not running.

Upon initiating the procedure, the UE shall:
1> stop timer T310 for the PCell, if running;
1> stop timer T312 for the PCell, if running;
release successHO-Config, if configured;

In an embodiment of the disclosure, the UE 101 releases SHR configuration during the transmission of MCGFailureInformation message.

### 5.7.3b.4 Actions Related to Transmission of MCGFailureInformation Message

The UE shall:
start timer T316;
1> release successHO-Config, if configured;
1> if SRB1 is configured as split SRB:
2> submit the MCGFailureInformation message to lower layers for transmission via SRB1, upon which the procedure ends;
1> else (i.e., SRB3 configured):
2> submit the MCGFailureInformation message to lower layers for transmission embedded in NR RRC message ULInformationTransferMRDC via SRB3 as specified in 5.7.2a.3

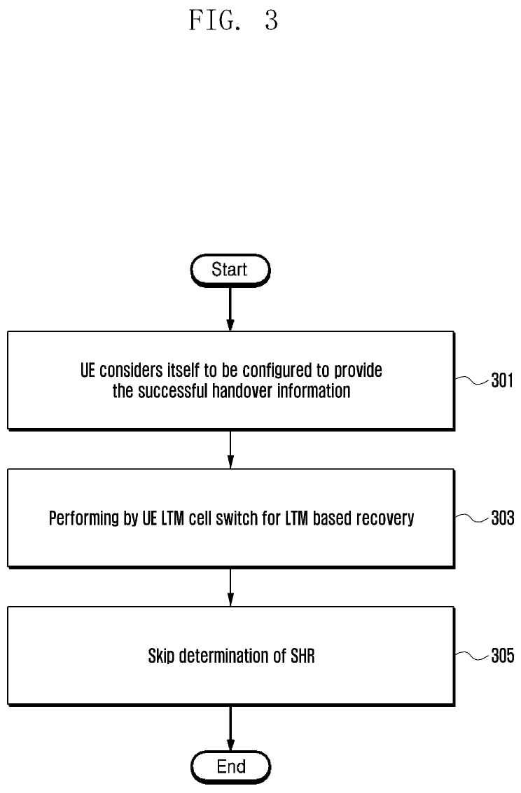

FIG. 3 is a flow diagram that illustrates a method for handling SHR for LTM based recovery by a UE according to an embodiment of the disclosure.

Referring to FIG. 3, at operation 301 the method includes considering by the UE 101 to be configured to provide the successful handover information. Network may provide a configuration, such as SHR configuration to the UE in the RRC messages, such as RRCReconfiguration, and the UE considers itself as configured for providing successful handover information.

At operation 303 the method includes performing by the UE 101 the LTM cell switch for LTM based recovery. The UE 101 initiates the cell switch by selecting a LTM candidate cell after a radio link failure or LTM cell switch failure and applying the LTM configuration if the LTM candidate cell for LTM based recovery.

At operation 305 the method includes skip determination of the SHR by the UE 101. The UE 101 assesses the need for SHR based the type of the mobility. If the type of mobility is LTM based recovery, the UE determines that SHR is not required, the UE 101 skips the SHR process to save the memory and any stored SHR. The UE 101 then continues normal operation without initiating any additional logging.

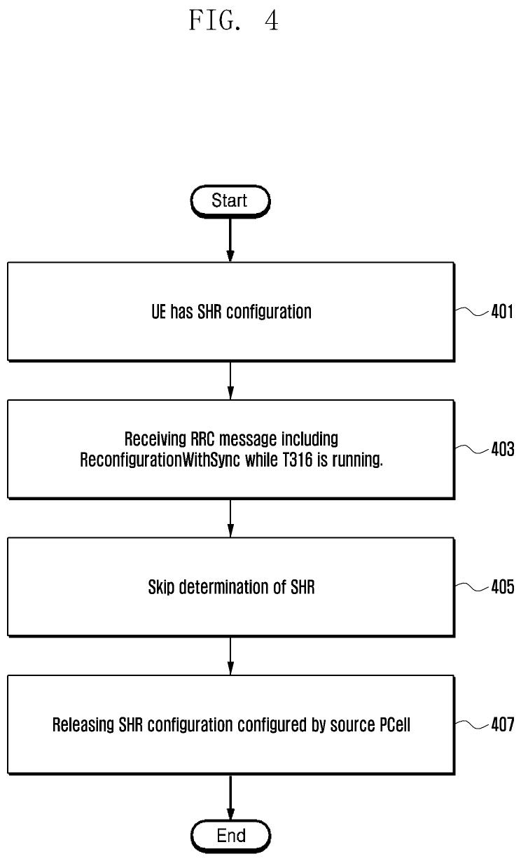

FIG. 4 is a flow diagram that illustrates a method for handling SHR configuration from source PCell while T316 is running according to an embodiment of the disclosure.

Referring to FIG. 4, at operation 401 the method includes considering by the UE 101 to be configured with SHR configuration. Network may provide a configuration, such as SHR configuration to the UE in the RRC messages, such as RRCReconfiguration, and the UE considers itself as configured for providing successful handover information.

At operation 403 the method includes receiving by the UE 101 the RRC message that includes Reconfiguration WithSync while the T316 timer is running. RRC message that includes Reconfiguration WithSync is normally used for handover.

At operation 405 the method includes skip determination of the SHR. The UE 101 evaluates the necessity of SHR based on the status of T316 timer. If the status of T316 timer is running, the UE 101 skips the SHR process. This decision helps to optimize the UE memory and reduce unnecessary signaling.

At operation 407 the method includes releasing the SHR configuration configured by the source PCell. The UE 101 clears the SHR configuration parameters from its memory. This action ensures that the UE 101 is ready to receive either new configuration settings from the target cell or not perform any operations based on outdated SHR configuration from the source PCell.

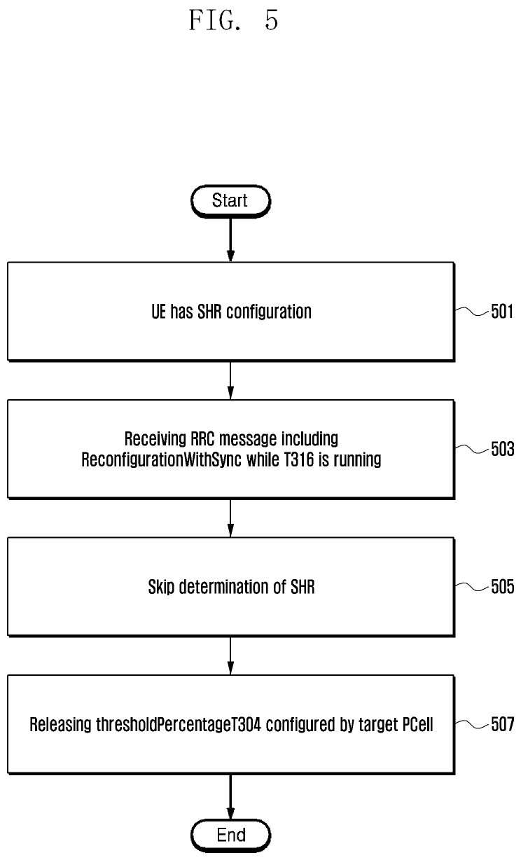

FIG. 5 is a flow diagram that illustrates a method for handling SHR configuration from target PCell while T316 is running according to an embodiment of the disclosure.

Referring to FIG. 5, at operation 501 the method includes considering by the UE 101 to be configured with SHR configuration. Network may provide a configuration, such as SHR configuration to the UE in the RRC messages, such as RRCReconfiguration, and the UE considers itself as configured for providing successful handover information.

At operation 503 the method includes receiving by the UE 101 the RRC message that includes Reconfiguration WithSync while the T316 timer is running. RRC message that includes Reconfiguration WithSync is normally used for handover.

At operation 505 the method includes skip determination of the SHR. The UE 101 evaluates the necessity of SHR based on status of T316 timer. If the status of T316 timer is running, the UE 101 skips the SHR process. This decision helps to optimize the UE memory and reduce unnecessary signaling.

At operation 507 the method includes releasing by the UE 101 the threshold percentage T304 configured by the target PCell. The UE 101 clears the T304 threshold parameters from its memory and resets any related timers. This action ensures that the UE 101 is ready to receive either new configuration settings from a new target PCell or not perform any operations based on outdated SHR configuration from the current target PCell.

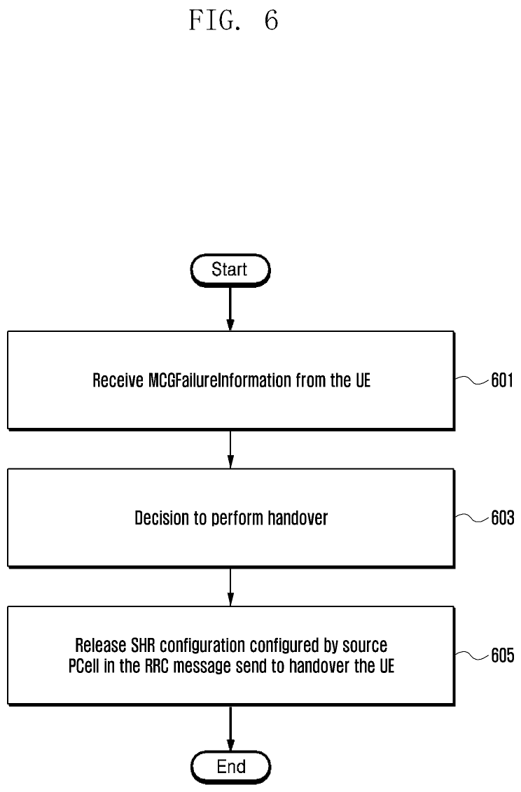

FIG. 6 is a flow diagram that illustrates a method for gNB handling SHR configuration during fast MCG link recovery according to an embodiment of the disclosure.

Referring to FIG. 6, at operation 601 the method includes receiving by gNB the MCGFailureInformation from the UE 101. The gNB processes the MCGFailureInformation to determine the cause of the failure and the current state of the UE 101. This information is used to make informed decisions about the recovery process. The gNB may also log this information for future analysis and optimization of the network. At operation 603 the method includes performing by the gNB the decision for the handover. The gNB evaluates the current network conditions and the state of the UE to determine the best target cell for the handover. The gNB then initiates the handover process by sending the necessary signaling messages to the target cell and the UE. This ensures a seamless mobility for the UE to the new cell.

At operation 605 the method includes instructing by the gNB the UE for releasing the SHR configuration configured by the source PCell in the RRC message sent to handover the UE 101. This action ensures that the UE 101 is ready to receive either new configuration settings from the target cell or not perform any operations based on outdated SHR configuration from the source PCell.

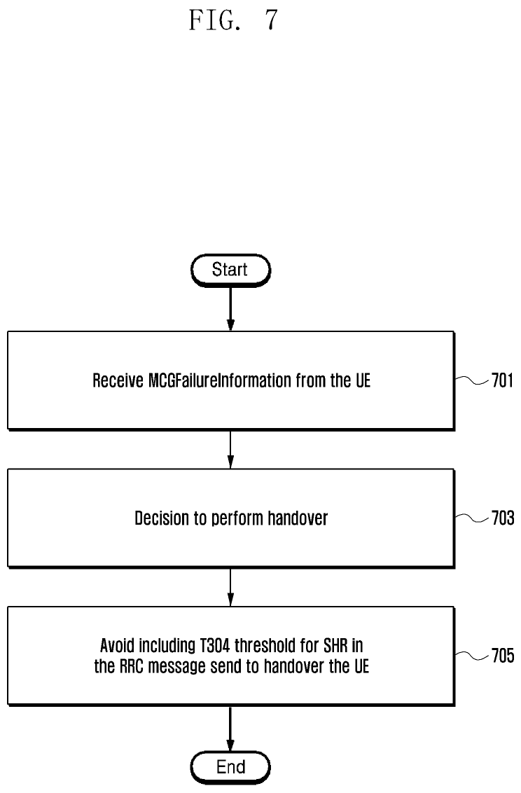

FIG. 7 is a flow diagram that illustrates a method for gNB handling SHR configuration during fast MCG link recovery according to an embodiment of the disclosure.

Referring to FIG. 7, at operation 701 the method includes receiving by the gNB MCGFailureInformation from the UE 101. The gNB processes the MCGFailureInformation to determine the cause of the failure and the current state of the UE 101. This information is used to make informed decisions about the recovery process. The gNB may also log this information for future analysis and optimization of the network. At operation 703 the method includes making a decision by the gNB to perform handover. The gNB evaluates the current network conditions and the state of the UE 101 to determine the best target cell for the handover. The gNB then initiates the handover process by sending the necessary signaling messages to the target cell and the UE 101. This ensures a seamless mobility for the UE 101 to the new cell.

At operation 705 the method includes avoiding including by the gNB T304 threshold for the SHR in the RRC message sent to handover the UE 101. The gNB omits the T304 threshold parameters from the RRC message to restrict the UE from performing SHR determination. This decision helps to reduce the signaling overhead and save UE memory.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a user equipment (UE) in a wireless communication system, the method comprising:
receiving, from a base station, a radio resource control (RRC) reconfiguration message;
identifying whether a reconfigurationWithSync information element (IE) in a spCellConfig of a master cell group (MCG) is included in the RRC reconfiguration message;
identifying whether the UE is configured with a successHO-Config when connected to a source primary cell (PCell), in case that the reconfiguration WithSync IE is included in the RRC reconfiguration message; and
releasing the successHO-Config configured by the source PCell, based on the identification that the UE is configured with the successHO-Config when connected to the source PCell.

2. The method of claim 1, further comprising:
identifying whether the RRC reconfiguration message is received when a timer is running, in case that the UE is configured with the successHO-Config when connected to the source PCell,
wherein the successHO-Config configured by the source PCell is released, in case that the reception of the RRC reconfiguration message when the timer is running is identified.

3. The method of claim 2, wherein the timer is started, in case that an MCG failure information message is transmitted to the base station in response to detecting a radio link failure of the MCG.

4. The method of claim 1, further comprising:
releasing a thresholdPercentageT304 in case that the thresholdPercentageT304 is configured by a target PCell, based on the identification that the UE is configured with the successHO-Config when the UE is connected to the source PCell.

5. The method of claim 1, further comprising:
transmitting an RRC reconfiguration complete message to the base station.

6. The method of claim 5, wherein the RRC reconfiguration complete message is set based on the reception of the RRC reconfiguration message.

7. The method of claim 2, wherein actions for successful handover report determination are skipped, in case that the reception of the RRC reconfiguration message when the timer is running is identified.

8. A user equipment (UE) in a wireless communication system, the UE comprising:
memory storing instructions; and
processing circuitry coupled to the memory and configured, based at least partially on execution of the instructions, to cause the UE to:
receive, from a base station, a radio resource control (RRC) reconfiguration message,
identify whether a reconfiguration WithSync information element (IE) in a spCellConfig of a master cell group (MCG) is included in the RRC reconfiguration message,
identify whether the UE is configured with a successHO-Config when connected to a source primary cell (PCell), in case that the reconfiguration WithSync IE is included in the RRC reconfiguration message, and
release the successHO-Config configured by the source PCell, based on the identification that the UE is configured with the successHO-Config when connected to the source PCell.

9. The UE of claim 8, wherein the processing circuitry is further configured, based at least partially on the execution of the instructions, to cause the UE to:
identify whether the RRC reconfiguration message is received when a timer is running, in case that the UE is configured with the successHO-Config when connected to the source PCell,
wherein the successHO-Config configured by the source PCell is released, in case that the reception of the RRC reconfiguration message when the timer is running is identified.

10. The UE of claim 9, wherein the timer is started, in case that an MCG failure information message is transmitted to the base station in response to detecting a radio link failure of the MCG.

11. The UE of claim 8, wherein the processing circuitry is further configured, based at least partially on the execution of the instructions, to cause the UE to:
release a thresholdPercentageT304 in case that the thresholdPercentageT304 is configured by a target PCell, based on the identification that the UE is configured with the successHO-Config when the UE is connected to the source PCell.

12. The UE of claim 8, wherein the processing circuitry is further configured, based at least partially on the execution of the instructions, to cause the UE to:
transmit an RRC reconfiguration complete message to the base station.

13. The UE of claim 12, wherein the RRC reconfiguration complete message is set based on the reception of the RRC reconfiguration message.

14. The UE of claim 9, wherein actions for successful handover report determination are skipped, in case that the reception of the RRC reconfiguration message when the timer is running is identified.
